(19) United States
(12) Patent Application Publication
(10) Pub. No.: US 2017/0348874 A1
(43) Pub. Date: Dec. 7, 2017

(54) SEMI-FINISHED FIBER PRODUCT LAY-UP HEAD

(71) Applicant: DEUTSCHES ZENTRUM FÜR LUFT- UND RAUMFAHRT E.V., KöIn (DE)

(72) Inventors: Yannis GROHMANN, Hamburg (DE); Fabian ZACHARIAS, Stade (DE)

(21) Appl. No.: 15/535,923

(22) PCT Filed: Dec. 18, 2014
(86) PCT No.: PCT/EP2014/078398

§ 371 Date: Jun. 14, 2017

(51) Int. Cl. B29B 11/16; B29C 35/02; B29C 70/38

(52) U.S. Cl. CPC B29B 11/16; B29C 70/38; B29C 35/0272; B29C 2035/0211

(57) ABSTRACT

The invention relates to a semi-finished fiber product lay-up head (1) for laying flat semi-finished fiber products (2), the semi-finished fiber product lay-up head having an electrically conductive electrode (6) which is contacted with the semi-finished fiber products to be layed, so that a current flow from a corresponding counter-electrode (7) in the fiber semi-finished product is effected in order to heat the same.

The invention relates to a semi-finished fiber product lay-up head for laying semi-finished fiber products in or on a molding tool. The invention likewise relates to a fiber laying device and to a method therefor.

The aerospace sector nowadays is inconceivable without components from a fiber-composite material, so-called fiber-composite components. However, the use of materials of this kind is becoming more popular in the automotive sector, too. By virtue of the high weight-specific strength and rigidity at minimum weight, it is in particular critical structural elements that are made from fiber-reinforced plastics. By way of the anisotropic properties of the fiber-composite materials that result from the fiber orientation, components can be adapted exactly to local stresses, and thus enable an optimal utilization of material in the context of a lightweight construction.

Apart from dry semi-finished fiber products such as scrims, woven fabric, or else mostly pre-bonded dry rovings, so-called prepregs (semi-finished fiber products that are pre-impregnated with a matrix material) are also used in the manufacturing process. On account of the ever increasing volumes in the production of fiber-reinforced components, in particular the mass production thereof, there are great endeavors to automate the manufacturing process to the largest extent, without thereby negatively influencing the quality of the manufacturing process or of the components to be manufactured, respectively.

In order for the later component shape to be created from the semi-finished fiber products, it is not uncommon for the semi-finished fiber products to be laid up in or on a molding tool, for example while exerting an external force, where the tool surface of said molding tool has a geometry that corresponds to the later component shape, or has a precursor to the latter. This laying-up process (often also referred to as preforming), in particular in the automated manufacturing process, is carried out with the aid of fiber laying devices (gantry systems, robotic systems) in which the final effectors are so-called semi-finished fiber product lay-up heads. Semi-finished fiber products, in particular planar semi-finished fiber products, tapes, slit tapes, or rovings, are infed to lay-up heads of this type by means of a material supply installation, such that said semi-finished fiber products can be laid up in or on the molding tool.

Specifically in the case of large components such as, for example, wing shells or rotor blades of wind power plants, the semi-finished fiber products that are provided as yard ware are laid up across a large area on the tool mold. In particular in the case of a multi-tier construction, the requirement then arises for the individual tiers herein to be mutually adhered or affixed, respectively, so as to avoid slipping or displacing of the semi-finished fiber products that have been laid up in a highly precise manner, said slipping or displacing potentially arising for example by heating of the semi-finished fiber products. This set of problems is additionally aggravated when the semi-finished fiber products are to be laid up on a molding tool that is set up in a vertical manner.

Binder materials which have been incorporated in pulverulent form or in the form of a non-woven, for example, are suitable for affixing on the one hand, for example. These binder materials can then be thermally activated by inputting thermal energy into the semi-finished fiber products, such that the individual semi-finished fiber products are caused to adhere. Moreover, in the case of the so-called prepregs, the tack and thus the mutual adhesion of the semi-finished fiber products can be enhanced by heating the semi-finished fiber products and the already pre-impregnated matrix material. Adhesion in order to avoid slipping or displacing of the semi-finished fiber products can also be achieved on account thereof. The semi-finished fiber products can then be fully cured conjointly with the injected matrix material in the subsequent manufacturing process. A further advantage of thermal energy in the case of so-called prepregs is that slightly heated prepregs have substantially improved processing properties, which makes the automated preform step significantly more reliable in terms of quality.

A repair method for a molded part from a plastics material, in which repair method a passive heating element which in a non-contacting manner is impinged on from the outside by an alternating magnetic field is provided in the repair region, is known from DE 10 2011 076 463 A1.

A method and a device for activating the binder of semi-finished fiber products, in which method and device two electrodes which are in contact with in particular the external peripheral regions of the preform are provided in the molding tool, are known from DE 103 530 70 A1. When a voltage is applied to the electrodes, a current flow through the preform takes place, leading to the binder being heated and thus activated. However, it is disadvantageous herein that the entire preform is to be heated, which in particular in the case of a preform having a large tiered construction leads to high current flows. This is because the current flow, on account of the arrangement of the electrodes in the molding tool, typically takes place through the lower semi-finished fiber product tiers such that an activation of the binder in comparatively high semi-finished fiber product tiers can only be achieved by way of high thermal radiation of the lower tiers and thus by way of a high current flow.

A molding tool for manufacturing fiber-composite components, in which a plurality of induction devices are provided in the molding tool so as to heat fiber-composite components that have been incorporated in the molding tool by means of induction, is known from DE 10 2011 108 157 A1.

A similar device is also known from DE 10 2006 040 049 A1, in which device the semi-finished fiber product tiers are disposed on the molding tool under a vacuum bag. The carbon fibers are mutually compressed by way of a pressure differential, wherein electric currents in the carbon fibers for activating the binder are generated with the aid of an alternating magnetic field.

A tape laying device in which the contact pressure roller is configured such that the laid-up fiber tapes can be impinged on by thermal energy with the aid of infrared radiation or induction is known from DE 10 2008 020 564 A1.

It is furthermore known in practice for the semi-finished fiber products to be heated by means of a laser or by means of infrared radiators, so as to achieve the desired effects. In the case of infrared radiators it has proven disadvantageous that the energy input into the semi-finished fiber products cannot be controlled in a targeted manner and is often insufficient. However, lasers are often expensive in terms of acquisition and maintenance.

Moreover, a further disadvantage when inputting thermal energy by means of ultrasound lies in the fact that plants of this type are very complex and expensive, on the one hand, and often severe fiber marcels which can cause defects in the component and are not acceptable in many applications are created by virtue of the excitation by ultrasound, on the other hand. Induction methods are very costly in terms of acquisition and cannot always be applied in a reproducible manner. Moreover, the shielding required when using microwaves represents a sizeable barrier to this technology.

It is thus the object of the present invention to specify an improved device and an improved method for laying semi-finished fiber products, by way of which device and method the heating of semi-finished fiber products can be simplified so as to design the lay-up process to be more rapid and more efficient without thereby influencing the quality of the later component in a negative manner.

The object of the present invention is achieved by the features of patent claim 1. The object is also achieved by coordinate independent patent claim 9. The object is moreover also achieved by the features of coordinate independent method claim 11.

Accordingly, a semi-finished fiber product lay-up head for laying semi-finished fiber products in or on a molding tool is proposed, wherein the lay-up head is configured for infeeding the semi-finished fiber products by way of a material supply installation. According to the invention, the semi-finished fiber product lay-up head has at least one electrical electrode that for applying a voltage is connectable to an electrical energy source and electrically contacts the infed semi-finished fiber products and interacts with at least one counter electrode that likewise electrically contacts the semi-finished fiber products in such a manner that a current flow is effected in a portion of the semi-finished fiber products that is defined by the contact with the electrode and the counter electrode.

It is thus proposed according to the invention that at least one electrode is disposed in the semi-finished fiber product lay-up head such that an exactly defined and regulatable current flow can be effected in at least part of the infed semi-finished fiber products. The semi-finished fiber products are heated by the current flow through the infed semi-finished fiber products such that thermal energy can be input into the semi-finished fiber products with the aid of the defined current flow. For example, a binder for affixing the semi-finished fiber products can be activated with the aid of the thermal energy input. On account thereof, optimal adhesion of the fibers to the laying-up base (either the tool or previously laid-up fiber tiers) is guaranteed during the fiber lay-up process. Moreover, in the case of prepregs, the processing properties are substantially improved by the thermal energy input, specifically at exactly that point where said improved processing properties are required for the lay-up process.

In the case of thermoplastic prepregs, the matrix is fused such that a consolidation can take place directly when the semi-finished fiber products are being laid-up. In the case of thermosetting plastic prepregs, the adhesion is improved by heating.

It is indeed known per se for heating of the semi-finished fiber products to be achieved with the aid of a current flow that is effected in the semi-finished fiber products. However, by contrast to known methods, the input of energy is very precise and is controllable and regulatable in a direct manner such that heating is possible in a very targeted and precise manner. As compared to infrared, the energy input herein is higher, wherein heat can be generated in such a manner where such heat is required, specifically between the fibers. Heating of the semi-finished fiber products to be laid up which is limited to only local areas can thus be achieved, specifically already during the laying-up of the semi-finished fiber products. On account thereof, the construction of the plant required can be substantially simplified and at the same time be used in a flexible manner for any component geometry.

The inventors have recognized herein that by heating the semi-finished fiber products that are infed to the lay-up head in a locally delimited manner, sufficient affixing or improvement of the laying-up properties can be achieved such that any displacement or slippage of the individual semi-finished fiber products is avoided. In fact, the inventors have recognized that in particular semi-finished fiber products can also be securely laid-up on molding tools that are set up in a vertical manner with the aid of a lay-up head of this type, without having to risk that the semi-finished fiber products are released from the tool surface or from semi-finished fiber products that have already been laid-up. According to the invention, it has been recognized herein that a current flow in the region of the lay-up, or during the actual lay-up process, respectively, is sufficient for the heating that is necessary in order for the advantages described to be achieved.

Moreover, the invention permits heating of the semi-finished fiber products that is very precisely regulatable, reliable, and rapid, on account of which the semi-finished fiber products can be quickly and reliably affixed.

A semi-finished fiber product is understood to mean both dry semi-finished fiber products and pre-impregnated semi-finished fiber products, so-called prepregs. Semi-finished fiber products that are pre-impregnated with thermoplastic or thermosetting plastic matrix materials are also subsumed in the case of prepregs.

Affixing the semi-finished fiber products herein is understood to mean in particular that semi-finished fiber products that bear on one another are interconnected in a materially integral manner, for example by activating a binder material or by fusing or heating an already pre-impregnated matrix material or other plastics compounds. Affixing the semi-finished fiber products is intended to generate mutual adhesion of the semi-finished fiber products such that any displacement of the semi-finished fiber products in the further manufacturing process can be avoided, or a consolidation in order for the geometry of the laid-up fiber material to be affixed be achieved.

A semi-finished fiber product lay-up head of this type typically has at least one lay-up unit which is configured for laying up the semi-finished fiber products that are infed to the semi-finished fiber product lay-up head in or on the molding tool. Such a lay-up unit can be a lay-up roll or lay-up roller, for example, or else a correspondingly shaped sliding block. The planar semi-finished fiber products that are infed to the lay-up head herein are guided along the lay-up unit such that at least one side of the semi-finished fiber products point in the lay-up direction and can thus be introduced into or onto the molding tool. Such a lay-up unit furthermore also serves for causing the force that is required for the lay-up and the adhesion in a process-reliable manner. The semi-finished fiber products with the aid of the lay-up unit are thus pushed onto or into the molding tool by way of a predetermined force.

The at least one electrode of the semi-finished fiber product lay-up head is advantageously
at least partially disposed on the at least one lay-up unit;
formed by the at least one lay-up unit per se; or
disposed ahead of or behind the lay-up unit in relation to the infeeding direction of the infed semi-finished fiber products.

It is thus conceivable that the electrode is at least partially disposed on the lay-up unit. It is thus particularly advantageous, for example when, in the case of a lay-up roll or a lay-up roller being the lay-up unit, the electrode is provided entirely or at specific spacings on the circumference of the roll or roller such that a current flow can be set so as to depend on the contact angle during the lay-up. However, it is also conceivable that a corresponding electrically conductive material is disposed about the entire circumference of the lay-up roll in order for the electrode to be formed in the semi-finished fiber product lay-up head.

It is also conceivable that the electrode is formed by the at least one lay-up unit per se, in that the lay-up unit per se is composed of an electrically conductive material. The lay-up unit can thus be, for example, a lay-up roll from a metallic material.

It is furthermore conceivable that the electrode in relation to the infeeding direction of the infed semi-finished fiber products is disposed ahead of or behind the lay-up unit. This is advantageous, for example, when the counter electrode is not disposed in the semi-finished fiber product lay-up head but outside, for example in the material supply device or in the molding tool. If the electrode of the semi-finished fiber product lay-up head in the infeeding direction is disposed ahead of the lay-up unit, a current flow emanating from the contact with the electrode up to the contact between the semi-finished fiber products and the molding tool, the latter contact being typically defined by the lay-up unit, results in the case of a counter electrode in the molding tool.

It thus becomes possible for a current flow in the semi-finished fiber products that are infed to the lay-up head to be effected before the semi-finished fiber products are laid up, while the semi-finished fiber products are being laid up, or shortly after said semi-finished fiber products have been laid up. Heating can be achieved on account thereof in a targeted and locally greatly delimited manner, such heating having proved to be particularly advantageous for adhering the semi-finished fiber products to or in the molding tool in a corresponding manner.

In one further advantageous embodiment, the at least one counter electrode which for the current flow interacts with the electrode in a corresponding manner is disposed in or on the semi-finished fiber product lay-up head, specifically in such a manner that the at least one counter electrode electrically contacts the semi-finished fiber products that are infed to the semi-finished fiber product lay-up head. A current flow between the electrode and the counter electrode is then effected across the corresponding portion of the semi-finished fiber products.

This exemplary embodiment has the particular advantage that the electrode and the counter electrode are provided conjointly in the lay-up head such that a corresponding fiber laying device does not require any additional counter electrode in the molding tool, for example. This simplifies the construction and the flexibility of the plants and final effectors used. It is advantageous herein when the counter electrode in relation to the infeeding direction of the infed semi-finished fiber products is disposed ahead of or behind the at least one electrode, so as to be spaced apart from the latter. On account thereof, a current flow for heating can be effected continuously in one portion of the infed semi-finished fiber products.

However, it is also conceivable that the counter electrode in relation to a lay-up unit that is provided on the semi-finished fiber product lay-up head in the infeeding direction is disposed ahead of or behind the lay-up unit. In turn, in conjunction with an electrode on the lay-up unit, a corresponding current flow is thus effected in a specific portion of the semi-finished fiber products.

In one advantageous embodiment, at least two lay-up units which for laying up infed semi-finished fiber products are configured beside one another or behind one another are disposed on the lay-up head. The one lay-up unit herein is configured such that said lay-up unit is provided as the electrode, while the other lay-up unit forms the counter electrode, such that a current flow is effected between the two lay-up units in a portion of the infed semi-finished fiber products.

In one further advantageous embodiment, it is proposed that the infed semi-finished fiber products contact the electrode on a first side of the semi-finished fiber products, while the counter electrode electrically contacts the semi-finished fiber products on a second side that is opposite the first side. It is thus conceivable that the electrode and the counter electrode are in each case provided on opposite sides such that a current flow through the planar semi-finished fiber products is effected.

In one further advantageous embodiment, for compacting the fibers of the semi-finished fiber products, the at least one electrode, the at least one counter electrode, at least one of the lay-up units, and/or the semi-finished fiber product lay-up head per se are/is configured for exerting a force in the direction of the infed semi-finished fiber products, such that an improved current flow through the semi-finished fiber product is effected in the region of compacting in the region of the electrodes and/or counter electrodes, since the transfer resistance between the electrode/counter electrode and the fiber material, as well as within the fiber material, is reduced. On account thereof, the energy input into the semi-finished fiber product can be controlled in a targeted manner.

In one further advantageous embodiment, the semi-finished fiber product lay-up head has at least one roller which across a circumferential face contacts the infed semi-finished fiber products and which in the circumferential face thereof has the at least one electrode and/or counter electrode for electrically contacting the semi-finished fiber products. A roller pair which is composed of at least two rollers can also be provided herein, wherein the one roller carries the electrode and the other roller carries the counter electrode, or where one roller pair has exclusively the electrodes, and another roller pair has exclusively the counter electrodes. It is advantageous herein too for the at least one roller to be configured for exerting a force in the direction of the semi-finished fiber products.

A plurality of rollers, each provided with an electrode and/or a counter electrode, can thus also be disposed in the lay-up head such that dissimilar contacting positions are reflected. It is also conceivable that both the electrode and the counter electrode are disposed (in a mutually isolated manner) on one roller, so as to effect a current flow that is transverse to the lay-up direction.

In one further embodiment, the electrodes and/or counter electrodes are disposed on the roller(s) so as to radially project from the latter, such that, on account thereof, the contact pressure force exerted is increased in the region of the electrodes and/or counter electrodes, which results in improved compacting. It is also conceivable that the electrodes and/or counter electrodes are distributed radially on the circumference of the roller, so as to follow a pattern, such that a corresponding contacting pattern over time is effected during the rotating movement of the roller. The electrode and the counter electrode herein can also be disposed in an alternating manner.

It is also conceivable that a plurality of electrodes and/or counter electrodes are provided in an encircling and axially spaced apart manner on one roller.

In one further advantageous embodiment, an output regulator unit is provided, which is adapted for regulating the electrical output of the current flow that is effected in the semi-finished fiber product so as to depend on a velocity of the semi-finished fiber product lay-up head. An output regulator unit of this type can be disposed in the lay-up head or in the electrical energy source that is connected to the lay-up head, for example. The electrical output can thus be lower in the case of lower velocities, for example, and be increased as the velocity increases. On account thereof, the advantage is achieved that no excessive energy input into the infed and/or laid-up semi-finished fiber products is caused during the start-up of the lay-up head at the beginning of the lay-up process, which can lead to damage to the semi-finished fiber products. Rather, the electrical output is regulated such that said electrical output adapts to the velocity of the lay-up head, in particular to the lay-up velocity.

In one further advantageous embodiment, the lay-up head has a plurality of electrical electrodes and optionally a plurality of electrical counter electrodes, wherein an electrode controller unit is provided, which is adapted for applying an electrical voltage in each case sequentially to one of the electrodes, and to switch the remaining electrodes and/or counter electrodes in such a manner that a current flow is effected between the respective electrode and a predefined counter electrode. A voltage in order to effect a current flow is thus applied sequentially to each electrode, wherein the corresponding remaining electrodes and counter electrodes are switched such that a current flow is effected exactly between that electrode to which the voltage has been applied and a defined counter electrode. On account thereof, the advantage that adequate temperature control across a large area can be achieved in particular in the case of large-area semi-finished fiber products is achieved. The electrodes are switched in this case sequentially one after the other. The electrode controller unit can be a component part of the semi-finished fiber product lay-up head, or be a component part of the electrical energy source, for example.

The electrodes and optionally the counter electrodes herein can be disposed so as to be mutually spaced apart in the semi-finished fiber product lay-up head, for example be spaced apart in the infeeding direction or be spaced apart orthogonally to the infeeding direction.

Moreover, it is particularly advantageous when the one controller unit is provided which, for controlling the application of the voltage to the electrode and/or counter electrode, is adapted such that a defined energy input into the semi-finished fiber product is caused. The controller unit is advantageously adapted in such a manner that the energy input is temporally controlled by controlling the application of the voltage, for example in such a manner that a predefined input of energy per unit of area and/or length of the semi-finished fiber products is caused. Moreover, it is advantageous herein when the energy source, in the case of a plurality of electrodes and/or counter electrodes, is adapted by means of the controller unit such that the electrodes and/or counter electrodes can be actuated separately, on account of which the most varied current-flow patterns can be generated within the semi-finished fiber products.

The object is moreover achieved by a fiber laying device for producing a fiber scrim of a fiber-composite component, according to claim 9, having a molding tool for laying up semi-finished fiber products, and having at least one semi-finished fiber product lay-up head as has been described above. In one advantageous embodiment, the at least one electrode is disposed in the semi-finished fiber product lay-up head, while the at least one counter electrode is formed by the molding tool or by an at least partially electrically conducting tool surface.

The invention will be explained in an exemplary manner by means of the appended figures in which:

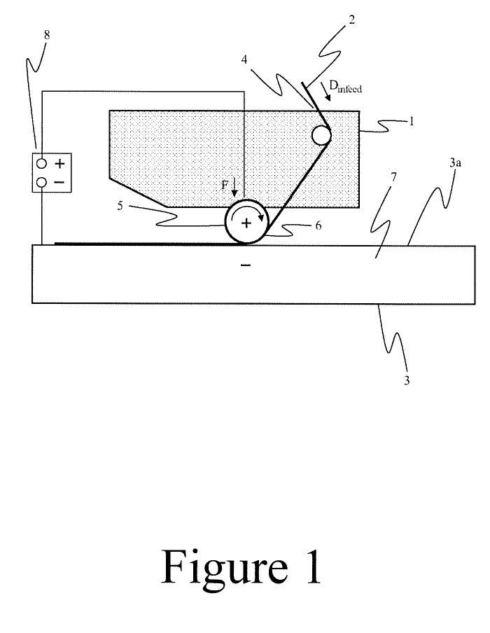

FIG. 1 shows a schematic illustration of a lay-up head having an electrode;

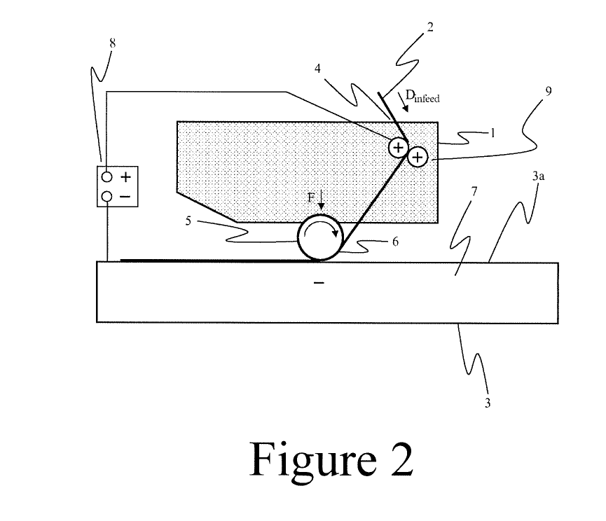

FIG. 2 shows a schematic illustration of a lay-up head having an upstream electrode roller pair;

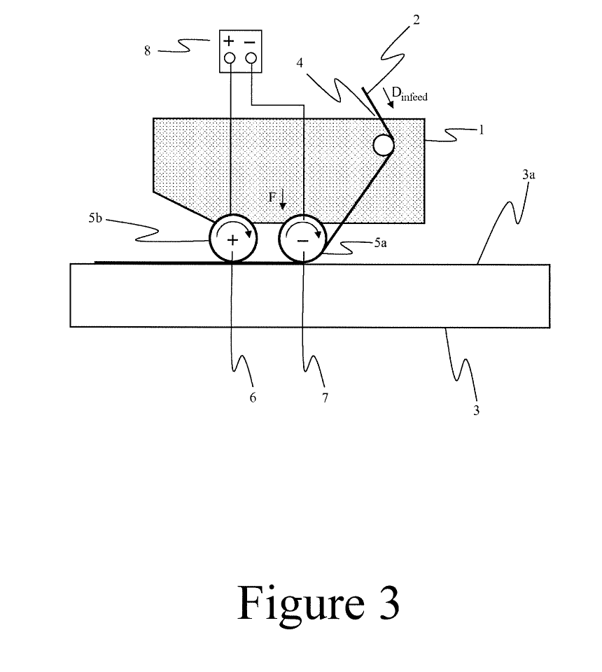

FIG. 3 shows a schematic illustration of a lay-up head having two lay-up units;

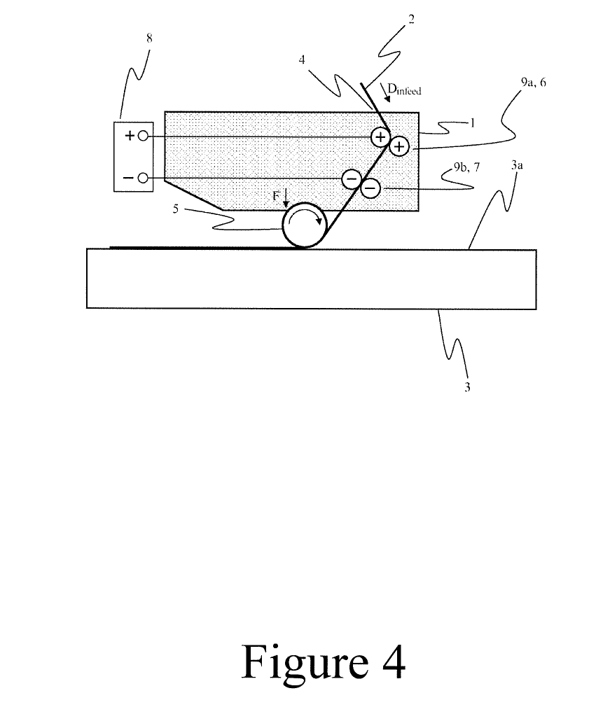

FIG. 4 shows a schematic illustration of a lay-up head having an upstream electrode and counter electrode;

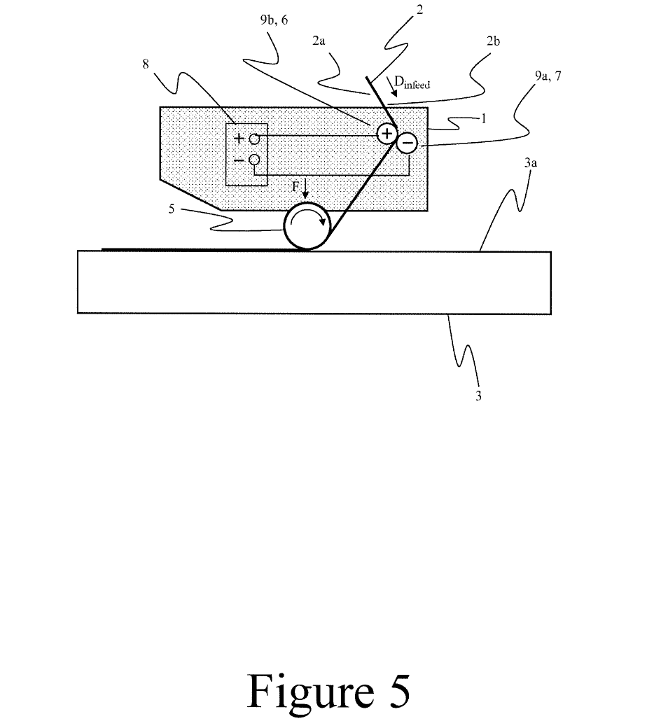

FIG. 5 shows a schematic illustration of a lay-up head having an electrode and a counter electrode in a mutually opposite manner;

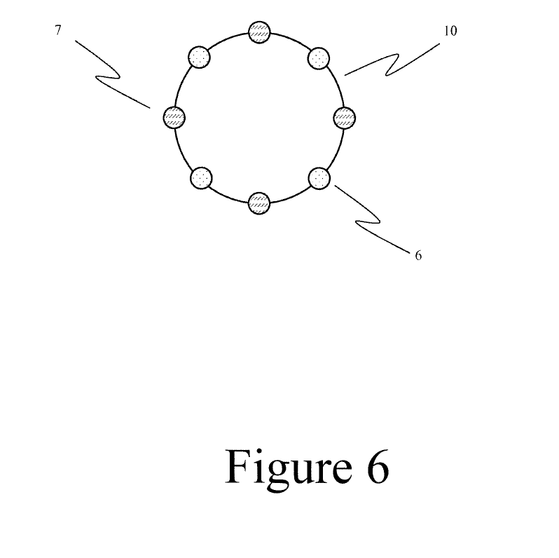

FIG. 6 shows a schematic illustration of a contact roller in a particular embodiment.

The invention will be explained hereunder by means of a plurality of exemplary embodiments. The same reference signs are in each case used for the same features in the various figures.

FIG. 1 schematically shows a lay-up head 1 by way of which semi-finished fiber products 2 can be laid up on a molding tool 3. The semi-finished fiber products 2 herein can be laid up directly onto the tool surface 3a of the molding tool or, when a multi-tiered construction of the fiber scrim is to be produced, also onto semi-finished fiber products that have already been laid up.

The lay-up head 1 has a fiber material infeed 4 by way of which the semi-finished fiber products 2 are infed to the lay-up head 1. The semi-finished fiber products 2 herein are infed by way of the fiber material infeed 4 from a material supply installation (not illustrated). A plurality of fiber material infeeds and material supply installations are also conceivable.

The semi-finished fiber products 2 that are infed by way of the fiber material infeed 4 are then guided by way of one or a plurality of deflection rollers across at least one lay-up unit 5 which in the exemplary embodiments of the figures is configured as a roll or lay-up roller, respectively. By guiding the semi-finished fiber products 2 on the lower side, the lay-up head 1 by way of the lay-up roller 5 continuously presses the fiber materials onto the tool 3, on account of which the semi-finished fiber products 2 are laid up on or in the molding tool 3.

In the exemplary embodiment illustrated in FIG. 1, the lay-up roll 5 is configured to be electrically conducting such that said lay-up roll 5 forms the electrode 6 of the lay-up head 1. To this end, the lay-up roll 5 can be composed of an electrically conductive material, or be sheathed by the latter. It is also conceivable that the lay-up roll 5 is equipped with an electrically conductive material only partially on the circumference, so as to form the electrode 6 of the lay-up head 1.

An electrically conductive molding tool 3 serves as the counter electrode 7 in the exemplary embodiment of FIG. 1, such that a current flow is effected in the semi-finished fiber products between the electrode 6 of the lay-up roll 5 and the electrically conductive tool 3 having its counter electrode 7, said semi-finished fiber products being located between the lay-up roll 5 and the molding tool 3. To this end, the electrode 6 and the counter electrode 7 are connected to an energy source 8 (a voltage source, for example), so as to apply a corresponding voltage to the electrode and/or the counter electrode, in order for the current flow to be effected.

Moreover, a force F in the direction of the molding tool 3 is applied by the lay-up head 1 and the lay-up roll 5 to the semi-finished fiber products 2 that are laid up or to be laid up during the lay-up process, such that compacting of the electrically conductive fiber material takes place in the region of the lay-up roll 5. On account of the defined compacting in the region of the lay-up roll 5, the semi-finished fiber products, or the fiber material, respectively, that are/is located in this region have/has a lower resistance than the surrounding regions, on account of which the main current flow is correspondingly established. In the exemplary embodiment of FIG. 1, said main current flow is almost perpendicular from the electrode 6 in the direction of the molding tool 3 as the counter electrode 7, this moreover improving the contact between the electrode 6 and the semi-finished fiber product 2.

In the case of lay-up heads in which the lay-up roll or the lay-up unit 5, respectively, is composed of silicone in order for flexible adapting to unevennesses of the tool to be achieved, the disposal of an electrode on the lay-up roll 5 is most often not expedient. To this end, it is proposed according to the exemplary embodiment of FIG. 2 that an upstream contact installation 9 forms the electrode 6. In the exemplary embodiment of FIG. 2, the contact installation 9 is configured as a roller pair such that a corresponding voltage can be applied both on the one side and on the opposite other side of the planar semi-finished fiber products 2 that are infed to the lay-up head 1. The molding tool also in this case is configured as the counter electrode 7 such that a current flow is effected here from the contact installation 9 up to the contact point between the semi-finished fiber products 2 and the molding tool 3 in the region of the lay-up roll 5.

The advantage of the exemplary embodiment of FIG. 2 lies in that a comparatively large portion of the semi-finished fiber products 2 is perfused by current such that heating that is more uniform than in the example of FIG. 1 can be expected here.

Since not every molding tool offers an electrically conductive surface, it is likewise necessary in the context of the invention for the required counter electrode to be provided on or in the lay-up head 1. A corresponding exemplary embodiment is shown in FIG. 3. The lay-up head 1 illustrated therein has two lay-up units 5a and 5b which are sequentially disposed in relation to the infeeding direction D_{infeed} of the infed semi-finished fiber products 2. It is also conceivable that the lay-up rolls 5a and 5b for a semi-finished fiber product 2 are disposed so as to be substantially beside one another or behind one another.

In the exemplary embodiment of FIG. 3, the counter electrode 7 is formed by the leading lay-up roll 5a, while the electrode 6 is formed by the trailing lay-up roll 5b. A current flow is effected in that region in which the infed semi-finished fiber products 2 contact the two lay-up rolls 5a and 5b when a corresponding voltage is applied by way of the energy source 8. On account thereof, the semi-finished fiber products, or the electrically conducting fibers of the semi-finished fiber products, respectively, are energized between the contact with the electrode and the counter electrode and thus heated. The lay-up head 1 in the exemplary embodiment of FIG. 4 has two contact installations 9a and 9b which in each case form the electrode 6 and the counter electrode 7, respectively. The contact installations 9a and 9b in FIG. 4 are in each case configured as roller pairs which in each case have two mutually opposite rollers for contacting the semi-finished fiber products 2 and are mutually compressed by way of a defined force such that compacting of the fibers can be achieved. To this end, the semi-finished fiber products are guided through between the two rollers, wherein the rollers (individually or conjointly) exert a force in the direction of the semi-finished fiber products. The semi-finished fiber products 2 are thus in form-fitting contact with the contact installations 9a and 9b such that an adequate electrical contact can be guaranteed.

The current flow in the semi-finished fiber products 2 is then effected in a portion between the two contact installations 9. The exemplary embodiment of FIG. 4 also has the advantage that no electrically conductive molding tool has to be provided in order for adequate heating to be achieved by energizing the semi-finished fiber products. Furthermore, a separation in terms of the functions of pressing the fiber materials and heating the fiber materials is achieved in this exemplary embodiment, on account of which the most varied materials can be used in principle for the lay-up roll.

In a manner similar to FIG. 1, FIG. 5 shows a linear heating of the fiber materials 2, in that a contact installation 9a bears in a contacting manner on a first side 2a of the semi-finished fiber products 2, while the second contact installation 9b bears in a contacting manner on a second side 2b of the semi-finished fiber products 2. The contact installation 9a herein is configured as the electrode, while the contact installation 9b is configured as the counter electrode, on account of which a current flow in the bearing region of the semi-finished fiber products 2 is effected in only a linear manner from the first side 2a to the second side 2b.

Also in the case of this variant, the fiber materials are compacted between the two contact installations 9a and 9b which are configured as rollers, on account of which the current flow is effected in the Z direction of the material, that is to say substantially orthogonal to the plane of the semi-finished fiber products. In order for the energy input to be increased, a connection of roller pairs in series is also conceivable.

FIG. 6 schematically shows a particular embodiment of a contact roller in cross section, in which a plurality of electrodes 6 and counter electrodes 7 are disposed about the circumference. In the exemplary embodiment of FIG. 6, an electrode and a counter electrode are disposed in an alternating manner on the circumference. Moreover, the electrodes and the counter electrodes are disposed such that they radially project from the contact roller 10 such that, when in contact with a semi-finished fiber product, an additional contact force can be exerted by way of these projecting electrodes and/or counter electrodes.

Of course, it is also conceivable that the electrodes and/or the counter electrodes of the contact roller 10 terminate so as to be flush with the circumferential face.

### LIST OF REFERENCE SIGNS

1 Semi-finished fiber product lay-up head
2 Planar semi-finished fiber products
2a First side of the semi-finished fiber products
2b Second side of the semi-finished fiber products
3 Molding tool
3a Tool surface
4 Fiber material infeed
5 Lay-up unit, lay-up roller
6 Electrode
7 Counter electrode
8 Voltage source
9, 9a, 9b Contact installations
10 Contact roller
F Contact pressure force
D_{infeed} Infeeding direction of the semi-finished fiber products

1. A semi-finished fiber product lay-up head for laying semi-finished fiber products in or on a molding tool or a combination of the semi-finished fiber product lay-up head and the molding tool, wherein the semi-finished fiber product lay-up head is configured for infeeding the semi-finished fiber products by way of a material supply installation, comprising:
at least one electrode for applying a voltage that is connectable to an electrical energy source, wherein the at least one electrode electrically contacts the semi-finished fiber products that are infed to the semi-finished fiber product lay-up head;
at least one counter electrode that electrically contacts the semi-finished fiber products that are infed to the semi-finished fiber product lay-up head,
wherein the at least one electrode interacts with the at least one counter electrode in such a manner that a current flow is effected in a portion of the semi-finished fiber products that is defined by the contact with the at least one electrode and the contact with the at least one counter electrode.

2. The semi-finished fiber product lay-up head or combination as claimed in claim 1, further comprising:
at least one lay-up unit which is configured for laying up the semi-finished fiber products that are infed to the semi-finished fiber product lay-up head in or on the molding tool,
wherein the at least one electrode
is at least partially disposed on the at least one lay-up unit;
is formed by the at least one lay-up unit; or
is disposed ahead of or behind the lay-up unit in relation to an infeeding direction (D_{infeed}) of the infed semi-finished fiber products.

3. The semi-finished fiber product lay-up head or combination as claimed in claim 1, wherein the at least one counter electrode is physically associated with the semi-finished fiber product lay-up head.

4. The semi-finished fiber product lay-up head or combination as claimed in claim 3, wherein the at least one counter electrode, in relation to an infeeding direction (D_{infeed}) of the infed semi-finished fiber products, is disposed ahead of or behind the at least one electrode so as to be spaced apart from the latter.

5. The semi-finished fiber product lay-up head or combination as claimed in claim 1, further comprising:
at least one lay-up unit which is configured for laying up the semi-finished fiber products that are infed to the semi-finished fiber product lay-up head in or on the molding tool,
wherein the at least one counter electrode in relation to an infeeding direction (D_{infeed}) of the infed semi-finished fiber products is disposed ahead of or behind the lay-up unit so as to be spaced apart from the latter.

6. The semi-finished fiber product lay-up head or combination as claimed in claim 1, comprising:
at least one first lay-up unit;
at least one second lay-up unit that is disposed spaced apart from the first lay-up unit,
wherein said first and second lay-up units are each configured for laying up the semi-finished fiber products that are infed to the semi-finished fiber product lay-up head in or on the molding tool,
wherein
the at least one electrode for electrically contacting the infed semi-finished fiber products is disposed on the first lay-up unit or is formed by the first lay-up unit; and
the at least one counter electrode for electrically contacting the infed semi-finished fiber products is disposed on the second lay-up unit or is formed by the second lay-up unit.

7. The semi-finished fiber product lay-up head or combination as claimed in claim 3, wherein the at least one electrode is disposed such that the infed semi-finished fiber products electrically contact the electrode on a first side, and the at least one counter electrode is disposed such that the infed semi-finished fiber products electrically contact the counter electrode on a second side that is opposite the first side.

8. The semi-finished fiber product lay-up head or combination as claimed in claim 7 wherein at least one of the first and second lay-up units is configured as a lay-up roller.

9. The semi-finished fiber product lay-up head or combination as claimed in claim 1, further comprising:
at least one roller which across a circumferential face of the at least one roller contacts the infed semi-finished fiber products and which in the circumferential face of the at least one roller has one or more of the at least one electrode and the at least one counter electrode for electrically contacting the semi-finished fiber products.

10. The semi-finished fiber product lay-up head or combination as claimed in claim 1 further comprising at least one lay up unit, and wherein one or more of the at least one electrode, the at least one counter electrode, the at least one lay-up unit, and the semi-finished fiber product lay-up head is configured for exerting a force in the direction of the infed semi-finished fiber products for compacting the fibers of the semi-finished fiber products.

11. The semi-finished fiber product lay-up head or combination as claimed in claim 1, further comprising:
an output regulator unit adapted for regulating electrical output of current flow that is effected in the semi-finished fiber product so as to depend on a velocity of the semi-finished fiber product lay-up head.

12. The semi-finished fiber product lay-up head or combination as claimed in claim 1 wherein the at least one electrode includes a plurality of electrical electrodes, and the at least one counter electrode includes a plurality of counter electrodes, and further comprising an electrode controller unit adapted for applying an electrical voltage in each case sequentially to one of the plurality of electrodes and to switch remaining electrodes of the plurality of electrodes and a portion of the plurality of counter electrodes in such a manner that a current flow is effected between the one of the plurality of electrodes and a predefined counter electrode of the plurality of counter electrodes.

13. A fiber laying device for producing a fiber scrim of a fiber-composite component, comprising:
a molding tool for laying semi-finished fiber products; and
a semi-finished fiber product lay-up head as claimed in claim 1.

14. The fiber laying device as claimed in claim 13 wherein the molding tool functions as the counter electrode and has an at least partially electrically conducting and shape-imparting tool surface.

15. A method for laying semi-finished fiber products in or on a molding tool, comprising:
a) providing a semi-finished fiber product lay-up head which lays up semi-finished fiber products that are infed thereto in or on the molding tool, wherein the semi-finished fiber product lay-up head has at least one electrode for electrically contacting the infed semi-finished fiber products;
b) providing at least one counter electrode for electrically contacting the semi-finished fiber products; and
c) applying a voltage to the at least one electrode and the at least one counter electrode so as to generate a current flow in a portion of the semi-finished fiber products that is defined by contact with the at least one electrode of the semi-finished fiber product lay-up head and contact with the at least one counter electrode when the semi-finished fiber products are being laid up in or on the molding tool.

16. The method as claimed in claim 15, wherein the a molding tool has an at least partially electrically conducting and shape-imparting tool surface for forming the at least one counter electrode, and comprising the step of laying up the semi-finished fiber products on the tool surface by the semi-finished fiber product lay-up head.

17. The method as claimed in claim 15 further comprising the step of compacting the fibers of the semi-finished fiber products using a contact pressure force in a direction of the semi-finished fiber products is-exerted by way of one or more of the at least one electrode, the at least one counter electrode, and the semi-finished fiber product lay-up head.
